(19) United States
(12) Patent Application Publication
(10) Pub. No.: US 2018/0372277 A1
(43) Pub. Date: Dec. 27, 2018

(54) LIGHTING DEVICE AND LAMP STRING

(71) Applicant: Gaole Zhang, Zhejiang (CN)

(72) Inventor: Gaole Zhang, Zhejiang (CN)

(21) Appl. No.: 15/662,428

(22) Filed: Jul. 28, 2017

(30) Foreign Application Priority Data
Jun. 22, 2017 (CN) 201710478902.X

(51) Int. Cl. F21K 9/237; F21V 23/06; F21V 3/04; F21V 17/12; F21K 9/232; F21K 9/235; F21S 4/10

(52) U.S. Cl. CPC F21K 9/237; F21V 23/06; F21V 3/0436; F21Y 2115/10; F21K 9/232; F21K 9/235; F21S 4/10; F21V 17/12

(57) ABSTRACT

Provided are a lighting device and a lamp string. The lighting device comprises a filament as a lighting body, a lamp base for supplying power to the lighting body, and a lamp shell for encapsulating, after connected with the lamp base, the lighting body therein to protect the lighting body and enable light emitted from the lighting body to pass therethrough. Through the detachable connection between the lamp base and the lamp shell, the lighting body is in detachable connection with the lamp base. A power-supply electrical wire of the lighting body directly comes out from the lamp base, and the lighting body and the lamp shell are directly connected with the lamp base, omitting a lamp holder. Moreover, due to its detachable property, when the lighting body is damaged, it can be replaced separately, rather than replacing the whole lighting device, greatly reducing the maintenance and usage cost.

### CROSS-REFERENCE TO RELATED APPLICATION

This application claims priority under 35 USC § 119 to Chinese Patent Application No. 201710478902.X, filed on Jun. 22, 2017 with the State Intellectual Property Office (SIPO) of the People's Republic of China, the contents of which are herein incorporated by reference in their entirety.

### TECHNICAL FIELD

The present application relates to the field of lighting fixture, and particularly to a lighting device and a lamp string.

### BACKGROUND ART

In daily-life lighting, lighting devices have a wide range of applications. The lighting device is a lamp which is used for lighting by using a resistor to heat filaments (generally tungsten filaments in modern times) to be incandescent when being powered on.

Existing lighting devices are usually encapsulated glass lighting devices of various types such as E14/E27/C7/C9, which need to be equipped with corresponding lamp holders, resulting in high cost, moreover, since a lighting body is encapsulated in a lamp shell, when the lighting body is damaged, the lighting device has to be wholly discarded, increasing the maintenance and usage cost.

### DISCLOSURE OF THE INVENTION

In view of this, an object of the present application is to provide a lighting device and a lamp string whose lighting body is replaceable and whose manufacturing cost, and maintenance and usage cost are low, in order to overcome shortcomings of the prior art.

In order to solve the above problems, a first solution provided in the present application is as follows:

a lighting device, includes a lamp shell, a lighting body provided in the lamp shell, and a lamp base connected with the lamp shell, the lamp base being connected with the lighting body, the lamp base is detachably connected with the lamp shell, and the lamp base is in detachable electrical connection with the lighting body.

In an exemplary example, the lighting device further includes a stand, the lighting body is provided in the stand, and the stand is in detachable electrical connection with the lamp base.

The stand is used to support the lighting body, and acts as a carrier of the lighting body to enable electrical connection between the lighting body and the lamp base. Through the detachable electrical connection between the stand and the lamp base, detachable electrical connection is formed between the lighting body and the lamp base.

In an exemplary example, the stand is electrically connected with the lamp base via a female connector and a male connector.

The electrical connection realized by the female and male connectors is electrical connection formed through connection between the male connector and the female connector. Such electrical connection has a stable electrical signal, is stable and easy to install and dismantle, and is a common electrical connection manner.

In an exemplary example, the lamp base is provided with an installation hole, and the female connector is inserted in the installation hole and fixed on the lamp base.

In an exemplary example, the stand is an ACRYLIC stand.

ACRYLIC, a type of organic glass, has relatively high plasticity, transparency, chemical stability and weather resistance, so that the stand has a light weight and high strength, and will not be easily damaged during transportation or repeated installation and dismantling.

In an exemplary example, the lamp shell is a plastic lamp shell, and the lamp base is a plastic lamp base.

The plastic lamp base and the plastic lamp shell have relatively high plasticity, chemical stability and weather resistance, and are easy to be colored, then the lamp shell and the lamp base of different colors can be chosen as required by actual usage, meanwhile, due to the properties of the plastic, the lamp shell and the lamp base have a light weight and high strength, and will not be easily damaged when being bumped in transportation or use. Moreover, when the lamp base and the lamp shell, both made of a plastic, are heated or cooled, expanding and shrinkage degrees are relatively synchronous, avoiding the case where a part with relatively poor strength is damaged in connection due to the disparity of hardness/strength.

In an exemplary example, the lamp base and the lamp shell are connected via threads.

The threaded connection enables relatively good detachability, meanwhile, the threaded connection is reliable and has relatively good sealing effect, so as to effectively prevent dust, liquid and other impurities from entering the lighting device.

In an exemplary example, the lighting body is an LED lighting body, and an operation voltage of the LED lighting body is DC 3 V-36 V.

The LED lighting body, having an operation voltage of DC 3 V-36 V, is a kind of low-voltage lighting body, has higher usage safety, does not need to be equipped with a corresponding lamp holder so that the cost is reduced, but requires a corresponding transformer for power supply.

In order to solve the above problems, a second solution provided in the present application is as follows:

a lamp string, includes a lamp wire, and further includes several above-mentioned lighting devices electrically connected onto the lamp wire.

In an exemplary example, both ends of the lamp wire are respectively provided with a male connector and a female connector.

By adding the male connector and the female connector at both ends of the lamp wire, lamp wires can be connected with each other, so that the lamp strings may be connected in series, or assembled as required by actual usage, so that the number of lighting devices is more flexible and varied.

Compared with the prior art, the present application has the following advantages:

1. Through the detachable connection between the lamp base and the lamp shell, the lighting body is are detachably connected with the lamp base. The power-supply wire of the lighting body directly comes out from the lamp base, and the lighting body and the lamp shell are directly connected with the lamp base, omitting a lamp holder, moreover, due to its detachable property, when the lighting body is damaged, the lighting body can be replaced separately, rather than replacing the whole lighting device, with simple operation and safe usage, greatly reducing the maintenance and usage cost.

2. As the lamp base is detachably connected with the lamp shell, the lamp shell of different shapes, e.g. spherical shape, ellipsoidal shape, strip shape, irregular shape, etc., can be replaced at any time, and these lamp shells have the same connecting portion, so that the lighting device has changeable and variable appearances.

3. The ACRYLIC stand is used to replace the conventional glass stand, the simple plastic lamp base is used to replace the screw lamp holder, and the plastic lamp shell is used to replace the glass lamp shell. The plastic and the ACRYLIC have relatively good processing property and plasticity, are featured by light weight and high strength, and are not prone to damage when being bumped, reducing the usage and maintenance cost and transportation and storage cost.

4. The low-voltage LED lighting body with DC 3-36 V is used, which has a low cost and higher safety.

5. The lighting devices are connected in parallel to form the lamp string, both ends of the lamp string are provided with the male connector and the female connector, respectively, and the lamp string with different number of lighting devices can be obtained by connecting them in series as required by usage.

In order to make it more obvious and easier to understand the above object, features and advantages of the present application, preferable examples are particularly illustrated in the following to make detailed description in conjunction with the accompanying drawings.

### BRIEF DESCRIPTION OF DRAWINGS

In order to more clearly illustrate technical solutions of Examples of the present application, figures which are needed for description of the examples will be introduced briefly below. It should be understood that the figures below merely show some examples of the present application, and therefore should not be considered as limiting the scope. A person ordinarily skilled in the art still can obtain other relevant figures according to these figures, without using inventive effort.

FIG. 1 shows a sectional structural schematic diagram of a lighting device provided in Example 1 of the present invention;

FIG. 2 is an exploded structural schematic diagram of the lighting device provided in Example 1 of the present invention;

FIG. 3 is a structural schematic diagram showing connection of a stand and a female connector of the lamp base of the lighting device provided in Example 1 of the present invention;

FIG. 4 is a structural schematic diagram of a lamp string provided in Example 2 of the present application;

FIG. 5 is a structural schematic diagram showing series connection of the lamp strings provided in Example 2 of the present application.

Reference signs: 1-lamp string; 10-lighting device; 101-lamp shell; 102-lighting body; 103-lamp base; 1031-female connector; 104-stand; 1041-male connector; 105-lamp cover; 20-lamp wire.

### DETAILED DESCRIPTION OF EMBODIMENTS

Below, various examples of the present application will be described more completely in conjunction with the figures. The present application can have various examples, and modifications and alterations can be made thereto. Therefore, the present application will be described with more details with reference to particular examples illustrated in the figures. However, it should be understood that it is not intended to limit the various examples of the present application to the particular examples of the present application, but the present application should be understood as covering all modifications, equivalents and/or optional solutions falling within the spirit and scope of the various examples of the present application. In connection with the description of the figures, like reference signs indicate like elements.

In the following text, terms “include” or “may include” used in various examples of the present application indicate presence of a claimed function, operation or element, and do not limit addition of one or more functions, operations or elements. Besides, as used in various examples of the present application, terms “include”, “have” and derivatives thereof are merely intended to indicate a specific feature, numeral, step, operation, element, assembly or combinations thereof, and should not be understood as firstly excluding presence of one or more other features, numerals, steps, operations, elements, assemblies or combinations thereof or the possibility of adding one or more other features, numerals, steps, operations, elements, assemblies or combinations thereof.

In various examples of the present application, expression “or” or “at least one of A or/and B” includes any combination or all combinations of the listed. For example, the expression “A or B” or “at least one of A or/and B” may include A, include B or include both A and B.

Expressions (such as “first”, “second”, etc.) used in various examples of the present application can define various constituent elements of the various examples, but may not limit corresponding composite elements. For example, the above expressions do not limit the order and/or importance of the elements. The above expressions are merely used for the purpose of distinguishing one element from other elements. For example, a first user device and a second use device indicate different user devices, even though both are user devices. For example, without departing from the scope of various examples of the present application, a first element can be called as a second element, likewise, the second element also can be called as the first element.

It should be noted that, if one constituent element is described as being “connected” to another constituent element, the first constituent element may be directly connected to a second constituent element, or a third constituent element may be “connected” between the first constituent element and the second constituent element. On the contrary, when one constituent element is “directly connected” to another constituent element, it can be understood that no third constituent element exists between the first constituent element and the second constituent element.

Terms used in various examples of the present application are merely for the purpose of describing particular examples, but are not intended to limit various examples of the present application. As used herein, a singular form is meant to also include a plural form, unless clearly dictated otherwise in the context. Unless otherwise specified, all terms (including technical terms and scientific terms) used herein have the same meanings as commonly understood by those ordinarily skilled in the art to various examples of the present application. The terms (such as terms defined in commonly used dictionaries) shall be understood as having the same meanings as in the contexts in relevant technical fields, and should not be construed as having ideal meanings or too formal meanings, unless clearly defined in various examples of the present application.

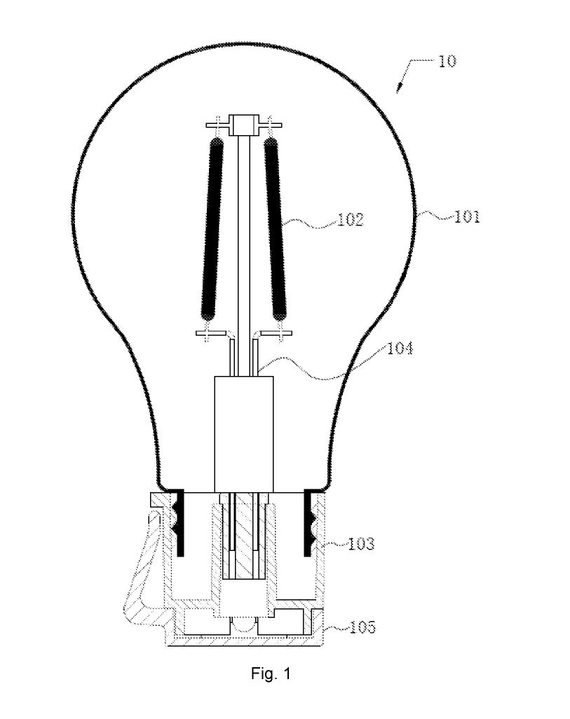

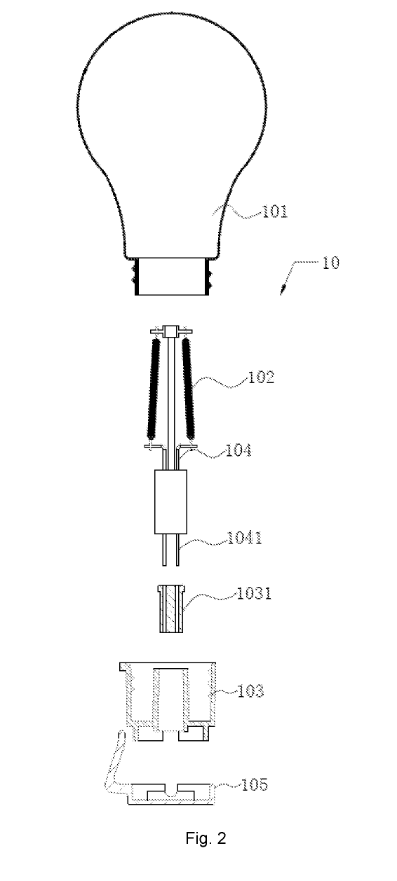

Referring to FIG. 1 and FIG. 2 together, a lighting device 10 includes a lamp shell 101, a lighting body 102 provided in the lamp shell 101, and a lamp base 103 connected with the lamp shell 101, the lamp base 103 being connected with the lighting body 102. The lamp base 103 is detachably connected with the lamp shell 101, and detachable electrical connection is formed between the lamp base 103 and the lighting body 102.

The lighting body 102 of the lighting device 10 of the present application is a lighting element, the lamp base 103 supplies power to the lighting body 102, and the lamp shell 101, after being connected with the lamp base 103, encapsulates the lighting body 102 therein to protect the lighting body 102 and enable light emitted from the lighting body 102 to pass therethrough. Through the detachable connection between the lamp base 103 and the lamp shell 101, the lighting body 102 and the lamp base 103 are detachably connected to each other. A power-supply wire of the lighting body 102 directly comes out from the lamp base 103. The lighting body 102 and the lamp shell 101 are directly connected with the lamp base 103, omitting a lamp holder. Moreover, due to its detachable property, when the lighting body 102 is damaged, the lighting body 102 can be replaced separately, rather than replacing the whole lighting device 10, greatly reducing the maintenance and usage cost.

Below, embodiments of the present application will be described in detail in conjunction with the figures.

### EXAMPLE 1

In the present example, the lighting device 10 further includes a stand 104, the lighting body 102 is provided in the stand 104, and the stand 104 is in detachable electrical connection with the lamp base 103.

The stand 104 is used to support the lighting body 102, and acts as a carrier of the lighting body 102 to enable electrical connection between the lighting body 102 and the lamp base 103. Through the detachable electrical connection between the stand 104 and the lamp base 103, detachable electrical connection is formed between the lighting body 102 and the lamp base 103.

Different from a conventional glass stand, the present stand 104 is an ACRYLIC stand 104.

ACRYLIC, a type of organic glass, has relatively high plasticity, overcomes shortcomings, e.g. high brittleness and easy damage, of the conventional glass, and will not produce sharp fragments even if damaged, which is safer for use. Meanwhile, ACRYLIC has crystalline transparency with light transmittance of no less than 92%, thereby reducing lighting loss of the lighting body 102. The ACRYLIC stand 104 has extremely good weather fastness, relatively high surface hardness and surface gloss, and relatively good high-temperature property, meanwhile, it also has good processing property, so as to be thermally formed, or also be mechanically processed. In the present example, the ACRYLIC stand 104 is formed via thermal forming.

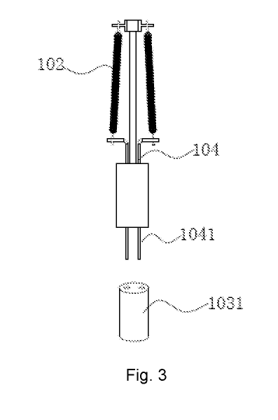

Referring to FIG. 3, the electrical connection is formed between the stand 104 and the lamp base 103 via female and male connectors.

The electrical connection realized by the female and male connectors is just electrical connection formed through connection between a male connector 1041 and a female connector 1031. Such electrical connection has a stable electrical signal, is stable and easy to install and dismantle, and is a common electrical connection manner.

In the present example, the stand 104 is provided with the male connector 1041, the male connector 1041 is in electrical connection with the lighting body 102 on the stand 104, and the lamp base 103 is provided thereon with the female connector 1031. The connecting manner of the female and male connectors is just a connecting manner of plug and socket, i.e. the stand 104 is provided with a plug, the lamp base 103 is provided with a jack in which electrical spring sheets are provided, and the plug inserted into the jack is tightly held by the spring sheets, so that the stand 104 and the lamp base 103 are connected more reliably and not easy to get loose, avoiding bad contact of the lighting body 102 caused by bad connection between the stand 104 and the lamp base.

It should be indicated that the female connector 1031 on the lamp base 103 is the female connector 1031 inserted in the lamp base 103. The lamp base 103 is provided with an installation hole, and the female connector 1031 is inserted in the installation hole so as to be fixed on the lamp base 103. A base body of the female connector 1031 is made from an insulating elastic rubber material, and the base body of the female connector 1031 is in a cylindrical shape. The lamp base 103 is provided with a circular hole. The female connector 1031 is fixed in the lamp base 103 via interference fit between the female connector 1031 and the circular hole.

In another example, the stand 104 is provided with the male connector 1041, the male connector 1041 is in electrical connection with the lighting body 102 on the stand 104, and the lamp base 103 is provided with the female connector 1031

In the present example, the lamp shell 101 is a plastic lamp shell 101, and the lamp base 103 is a plastic lamp base 103.

The plastic lamp base 103 and the plastic lamp shell 101 have relatively high plasticity, chemical stability and weather resistance, and are easy to be colored, then the lamp shell 101 and the lamp base 103 of different colors can be chosen as required by actual usage, meanwhile, due to the properties of the plastic, the lamp shell 101 and the lamp base 103 have a light weight and high strength, and will not be easily damaged when being bumped in transportation and use.

Moreover, when the lamp base 103 and the lamp shell 101, both made of a plastic, are heated or cooled, expanding and shrinkage degrees are relatively synchronous, avoiding the case where a part with relatively poor strength is damaged in connection due to the disparity of hardness/strength.

The lamp base 103 and the lamp shell 101 are connected via threads.

The threaded connection enables relatively good detachability, meanwhile, the threaded connection is reliable and has relatively good sealing effect, so as to effectively prevent dust, liquid and other impurities from entering the lighting device 10. In order to further enhance the dustproof and waterproof properties between the lamp shell 101 and the lamp base 103, a transparent waterproof sealing ring may be additionally provided at the place of the threaded connection.

In the present example, the lamp shell 101 is provided with external threads, the lamp base 103 is provided with internal threads, and connection is realized by screwing the lamp shell 101 on the lamp base 103. In order to achieve good connection sealability between the lamp base 103 and the lamp shell 101, a sealing ring is provided at a junction of the external threads of the lamp shell 101 with the lamp shell 101, and when the lamp shell 101 is connected with the lamp base 103, after the lamp shell 101 is screwed on the lamp base 103, the sealing ring is tightly pressed and deformed, thereby generating an elastic restoring force, so as to fill up a gap between the lamp base 103 and the lamp shell 101 and expand to be clamped tightly within the gap, thus achieving the sealing effect, preventing dust, liquid and other impurities from entering the lighting device 10, and prolonging the service life of the lighting device 10.

The lighting device 10 further includes a lamp cover 105. The lamp cover 105 is covered at an end portion of the lamp base 103, and is located at an end portion of the whole lighting device 10 for enclosing the lamp base 103. The lamp cover 105 is clamped over on the lamp base 103. The lamp cover 105 is further provided thereon with a hook. The hook is used to hang the lighting device 10 on a lamp cord or an electric wire.

In the present example, the lighting body 102 is embodied as an LED filament, and an operation voltage of the LED filament is direct current 3 V-36 V.

The LED filament, being a kind of stereoscopic light source emitting 360° of light, maximizes the power factor of the power supply, minimizes the cost, and is able to bring brand new vision of light, creating a natural luminous environment of “incandescent lamp”. The LED filament, having an operation voltage of direct current 3 V-36 V, is a kind of low-voltage LED filament, has higher usage safety, does not need to be equipped with a corresponding lamp holder so that the cost is reduced, but requires a corresponding transformer for power supply.

### EXAMPLE 2

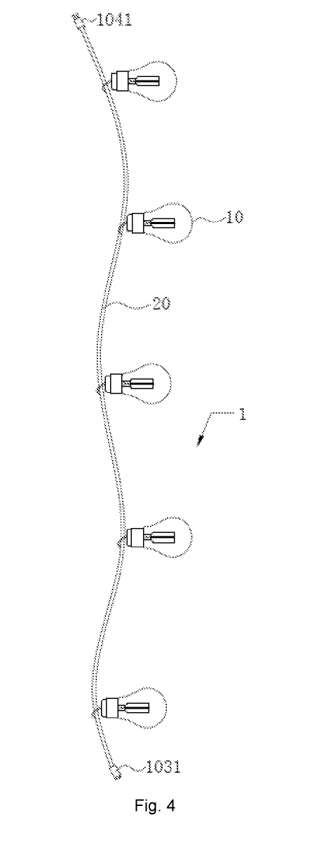

As shown in FIG. 4, the present example provides a lamp string 1, including the lighting devices 10 of Example 1 and a lamp wire 20, where several lighting devices 10 are electrically connected onto the lamp wire 20, and the electric wires coming out from the lamp bases 103 of the lighting devices 10 are connected onto the lamp wire 20, so as to form the lamp string 1.

The lamp wire 20 of the lamp string 1 of the present application is in direct electrical connection with the electric wires coming out from the lamp bases 103 of the lighting devices 10, rather than with the lamp bases 103, thus the cost of the lamp string 1 is low.

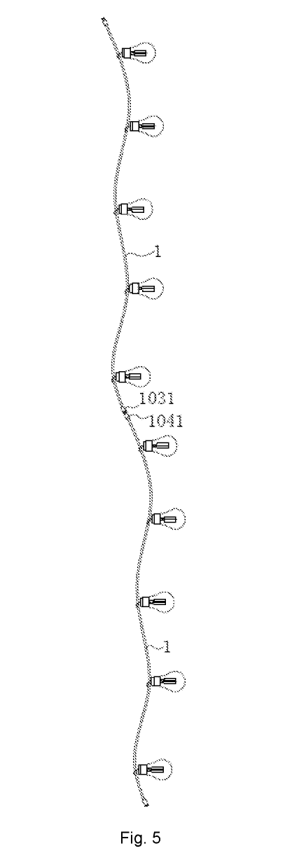

Referring to FIG. 5, the lamp wire 20 of the lamp string 1 of the present example has one end provided with a male connector 1041 and the other end provided with a female connector 1031. With the male connector 1041 and the female connector 1031 at both ends of the lamp wire 20, the lamp strings 1 can be connected to each other. Through connection of the male connector 1041 of one lamp wire 20 and the female connector 1031 on another lamp wire 20, two lamp wires 20 are in electrical connection, and a plurality of the lamp strings 1 can be serially connected together as required by usage. If 10 lighting devices 10 are provided on the lamp string 1, a 10-lighting device lamp string 1 is obtained, and if a lamp string 1 with no less than 100 lighting devices is desired, a plurality of the lamp strings 1 can be connected, and only one lamp string 1 needs to be supplied with power, reducing the wiring number of a plurality of lamp strings 1 so that the wiring is simpler, and making it suitable for multiple indoors and outdoors circumstances.

Meanwhile, usage of the supply voltage of DC 3-36 V requires a transformer for voltage transformation power supply, while a plurality of lamp strings 1 are electrically connected via the female and male connectors, the number of used transformer is reduced, the electrical connection circuit is simpler, moreover, the operation voltage is a low voltage, thus having high safety.

In all of the examples shown and described herein, any specific value should be explained as merely illustrative but not restrictive, therefore, other examples of the exemplary examples can have different values.

It should be noted that like numerals and letters indicate like items in the following figures, therefore, once a certain item is defined in one figure, it will not need to further define or explain the same in subsequent figures.

The above examples merely express several embodiments of the present application, and the description thereof is relatively concrete and minute, but should not be understood as limiting the scope of the present application. It should be indicated that for a person ordinarily skilled in the art, variations and improvements still can be made, without departing from the concept of the present application, all of which fall within the scope of protection of the present application.

1. A lighting device, comprising a lamp shell, a lighting body provided in the lamp shell, and a lamp base connected with the lamp shell, the lamp base being connected with the lighting body,
wherein the lamp base is detachably connected with the lamp shell, and the lamp base and the lighting body are in detachable electrical connection with each other.

2. The lighting device according to claim 1, wherein the lighting device further comprises a stand, the lighting body is provided in the stand, and the stand and the lamp base are in detachable electrical connection with each other.

3. The lighting device according to claim 2, wherein the stand is in electrical connection with the lamp base via a female connector and a male connector.

4. The lighting device according to claim 3, wherein the lamp base is provided with an installation hole, and the female connector is inserted in the installation hole and fixed on the lamp base.

5. The lighting device according to claim 2, wherein the stand is an ACRYLIC stand.

6. The lighting device according to claim 1, wherein the lamp shell is a plastic lamp shell, and the lamp base is a plastic lamp base.

7. The lighting device according to claim 1, wherein the lamp base and the lamp shell are connected via threads.

8. The lighting device according to claim 1, wherein the lighting body is an LED lighting body, and an operation voltage of the LED lighting body is direct current 3 V-36 V.

9. A lamp string, comprising a lamp wire, wherein the lamp string further comprises several lighting devices according to claim 1 electrically connected onto the lamp wire.

10. The lamp string according to claim 9, wherein the lighting device further comprises a stand, the lighting body is provided in the stand, and the stand and the lamp base are in detachable electrical connection with each other.

11. The lamp string according to claim 10, wherein the stand is in electrical connection with the lamp base via a female connector and a male connector.

12. The lamp string according to claim 11, wherein the lamp base is provided with an installation hole, and the female connector is inserted in the installation hole and fixed on the lamp base.

13. The lamp string according to claim 10, wherein the stand is an ACRYLIC stand.

14. The lamp string according to claim 9, wherein the lamp shell is a plastic lamp shell, and the lamp base is a plastic lamp base.

15. The lamp string according to claim 9, wherein the lamp base and the lamp shell are connected via threads.

16. The lamp string according to claim 9, wherein both ends of the lamp wire are respectively provided with a male connector and a female connector.
